(19) United States
(12) Patent Application Publication
(10) Pub. No.: US 2025/0269277 A1
(43) Pub. Date: Aug. 28, 2025

(54) GENERATION OF HIGHLIGHT REEL FROM STORED USER GENERATED CONTENT FOR A USER SPECIFIED TIME PERIOD

(71) Applicant: Sony Interactive Entertainment LLC, San Mateo, CA (US)

(72) Inventors: Angela Thanh Phan WEBB, San Lorenzo, CA (US); Bethany TINKLENBERG, Oakland, CA (US)

(21) Appl. No.: 18/590,538

(22) Filed: Feb. 28, 2024

(51) Int. Cl. A63F 13/497; A63F 13/88; G06N 3/0475

(52) U.S. Cl. CPC A63F 13/497; A63F 13/88; G06N 3/0475

(57) ABSTRACT

A method including receiving a request for a highlight reel of a video game, wherein the request includes a story class for the highlight reel, wherein the video game includes a plurality of playable events that are predefined, wherein the plurality of playable events are configured in an arc order consistent with a story arc of the video game. The method including selecting one or more playable events from the plurality of playable events to architect a mini story arc for the highlight reel based on the story class. The method including accessing a plurality of clips corresponding with the one or more playable events that are selected for the mini story arc. The method including generating the highlight reel based on the plurality of clips that follows the mini story arc that is architected with the one or more playable events.

### TECHNICAL FIELD

The present disclosure is related to building a highlight reel of a video game using stored game plays of the video game of various players. Generative artificial intelligence is used to generate a mini story arc that is filled in with playable events of the video game that are predefined. Further, the generative artificial intelligence is used to select user generated content corresponding with the selected playable events for building the highlight reel.

### BACKGROUND OF THE DISCLOSURE

Video games and/or gaming applications and their related industries (e.g., video gaming) are extremely popular and represent a large percentage of the worldwide entertainment market. Video games are played anywhere and at any time using various types of platforms, including gaming consoles, desktop computers, laptop computers, mobile phones, tablet computers, etc.

A user may be interested in a particular video game. For instance, the user may wish to play the video game but would like more information before purchasing, or the user may not actually have time to play the video game but would like to learn the story or lore of the video game, or the user may have set aside playing the video game and has forgotten key features in the storyline of the game. However, the user is unsatisfied with the limited amount of information released by the developer, and/or is unwilling to wade through the endless hours of streaming game plays available over social media just to run across the portions that are important to the user. That is, the user wishes to learn more about the game in a controlled and efficient manner that is enjoyable.

It is in this context that embodiments of the disclosure arise.

### SUMMARY

Embodiments of the present disclosure relate to providing a highlight reel of a video game. The highlight reel is built using stored game plays of the video game of various players. Generative artificial intelligence is configured to build a mini story arc for the highlight reel based on user preferences, such as a duration for the reel, and can also be configured to select playable events of the video game, from a complete list of playable events, for inclusion into the mini story arc. Generative artificial intelligence can be configured to select user generated content that correspond to the selected playable events, which are accessed and used for building the highlight reel.

In one embodiment, a method is disclosed. The method including receiving a request for a highlight reel of a video game, wherein the request includes a story class for the highlight reel, wherein the video game includes a plurality of playable events that are predefined, wherein the plurality of playable events are configured in an arc order consistent with a story arc of the video game. The method including selecting one or more playable events from the plurality of playable events to architect a mini story arc for the highlight reel based on the story class. The method including accessing a plurality of clips corresponding with the one or more playable events that are selected for the mini story arc. The method including generating the highlight reel based on the plurality of clips that follows the mini story arc that is architected with the one or more playable events.

In another embodiment, a computer system is disclosed, wherein the computer system includes a processor and memory coupled to the processor and having stored therein instructions that, if executed by the computer system, cause the computer system to execute a method. The method including receiving a request for a highlight reel of a video game, wherein the request includes a story class for the highlight reel, wherein the video game includes a plurality of playable events that are predefined, wherein the plurality of playable events are configured in an arc order consistent with a story arc of the video game. The method including selecting one or more playable events from the plurality of playable events to architect a mini story arc for the highlight reel based on the story class. The method including accessing a plurality of clips corresponding with the one or more playable events that are selected for the mini story arc. The method including generating the highlight reel based on the plurality of clips that follows the mini story arc that is architected with the one or more playable events.

In still another embodiment, a non-transitory computer-readable medium storing a computer program for implementing a method is disclosed. The computer-readable medium including program instructions for receiving a request for a highlight reel of a video game, wherein the request includes a story class for the highlight reel, wherein the video game includes a plurality of playable events that are predefined, wherein the plurality of playable events are configured in an arc order consistent with a story arc of the video game. The computer-readable medium including program instructions for selecting one or more playable events from the plurality of playable events to architect a mini story arc for the highlight reel based on the story class. The computer-readable medium including program instructions for accessing a plurality of clips corresponding with the one or more playable events that are selected for the mini story arc. The computer-readable medium including program instructions for generating the highlight reel based on the plurality of clips that follows the mini story arc that is architected with the one or more playable events.

Other aspects of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings in which:

FIG. 1 illustrates a system configured for building a highlight reel of a video game including clips of stored game plays of the video game that follow a mini story arc generated using generative artificial intelligence, in accordance with one embodiment of the present disclosure.

FIG. 2 is a flow diagram illustrating a method for building a highlight reel of a video game including clips of stored game plays of the video game that follow a mini story arc generated using generative artificial intelligence, in accordance with one embodiment of the present disclosure.

FIG. 3A is an illustration of a system configured to implement one or more artificial intelligence models configured for generating a mini story arc of the video game, filling the mini story arc with playable events in the video game, and selecting clips of stored game plays of the video game that follow the mini story arc that are modified and ordered to build a highlight reel of the video game, in accordance with one embodiment of the present disclosure.

FIG. 3B is an illustration of a system configured to implement an artificial intelligence model configured for generating a list of playable events that occur in a video game, in accordance with one embodiment of the present disclosure.

FIG. 4A is an illustration of the list of playable events introduced in FIG. 3B arranged in an arc order, and game plays of players that include one or more of the playable events, in accordance with one embodiment of the present disclosure.

FIG. 4B is an illustration of the list of playable events introduced in FIG. 3B that are categorized according to one or more levels of importance, in accordance with one embodiment of the present disclosure.

FIG. 4C is an illustration of a game play of player P1 that includes one or more playable events arranged sequentially as they are performed, and how the playable events are be categorized according to corresponding levels of performance, in accordance with one embodiment of the present disclosure.

FIG. 5 is a data flow diagram illustrating the selection of stored game plays of a video game or dynamic generation of game play of the video game that are modified and ordered to build a highlight reel of the video game, in accordance with one embodiment of the present disclosure.

FIG. 6 illustrates components of an example device that can be used to perform aspects of the various embodiments of the present disclosure.

### DETAILED DESCRIPTION

Although the following detailed description contains many specific details for the purposes of illustration, anyone of ordinary skill in the art will appreciate that many variations and alterations to the following details are within the scope of the present disclosure. Accordingly, the aspects of the present disclosure are set forth without any loss of generality to, and without imposing limitations upon, the claims that follow this description.

Generally speaking, the various embodiments of the present disclosure describe systems and methods for building a highlight reel of a video game using stored game plays of the video game of various players. In particular, generative artificial intelligence (AI) is implemented to generate a mini story arc of the video game, fill the mini story arc with predefined playable events of the video game, select clips of game plays of the video game stored as user generated content that correspond with the playable events filling the mini story arc, and modifying and ordering the selected clips to follow the mini story arc in order to build a highlight reel of the video game. In that manner, the user is able to view a highlight reel of the video game that follows a request of the user (e.g., story class, duration, etc.) and purposefully tells the lore of the video game. As such, the user is able to quickly learn the entire lore or portions of the lore of the video game, that may or may not include video game spoilers as per the desires of the user.

Advantages of the methods and systems configured to build a highlight reel of a video game, based on user generated content of game plays of the video game, include allowing the user to learn more about the video game in an enjoyable and efficient manner that is controlled by the user (e.g., requested story class, and/or duration of the highlight reel, revealing spoilers or not revealing spoilers, etc.). For instance, the user is a fan of the video game series and may want to learn more about this particular version of the video game, or the user just wants to learn more about the video game before purchasing the game, or the user may not have the skills or time to play the game, and would like to view what he or she is missing in not playing the game. As such, instead of the user randomly viewing posts of ordinary players or professional streamers playing the video game, embodiments of the present disclosure build a highlight reel from user generated content of game plays of the video game from multiple players, wherein the highlight reel follows a mini story arc that complies with a story class (e.g., simple and quick, medium story length, complex story, etc.) and/or a duration for the highlight reel. Another advantage includes minimizing the presence of hallucinations in the highlight reel even with the use of generative AI. In particular, hallucinations that are inherent when using generative AI to generate content may be avoided because the generative AI is primarily used to determine how to collapse the entirety of the game play of the video game into collapse points for the highlight reel, and generative AI is further used to pull the clips and/or video sequences from user generated content at one or more collapse points. That is, generative AI is not primarily used for generating content included within the highlight reel. In particular, hallucinations are avoided because the highlight reel is built from user generated content and not necessarily generated using generative AI technique's, wherein the pulled user generated content is modified and merged to form the highlight reel. Still another advantage includes dynamically generating a highlight reel that is unique for a particular user that includes the best parts of user generated content selected for inclusion within the highlight reel. The highlight reel is customized according to user desires, such as a story class requested, or specific time period or duration (e.g., 3 minutes, 5 minutes, 10 minutes, 20 minutes, etc.) of the highlight reel.

Throughout the specification, the reference to “game” or video game” or “gaming application” is meant to represent any type of interactive application that is directed through execution of input commands. For illustration purposes only, an interactive application includes applications for gaming, word processing, video processing, video game processing, etc. Also, the terms “virtual world” or “virtual environment” or “metaverse” is meant to represent any type of environment generated by a corresponding application or applications for interaction between a plurality of users in a multi-player session or multi-player gaming session. Furthermore, the term “platform” refers to a combination of hardware and software components providing a set of capabilities in order to execute one or more software applications (e.g., video games). For example, the term “platform” may be used with reference to “devices of a particular platform” or “cross-platform devices.” Moreover, suitable terms introduced above are interchangeable.

With the above general understanding of the various embodiments, example details of the embodiments will now be described with reference to the various drawings.

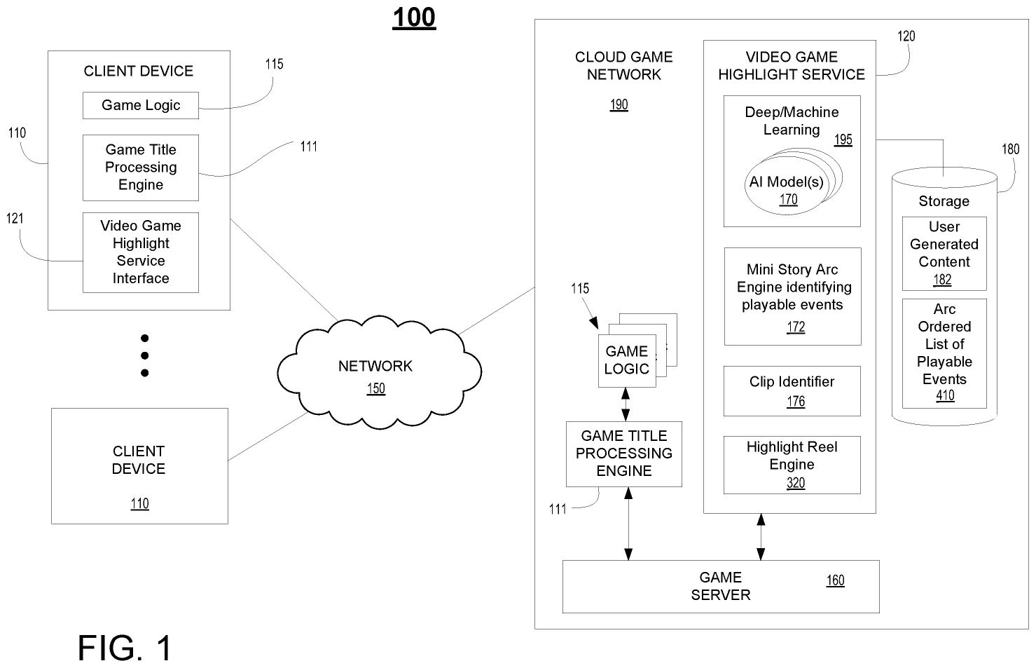

FIG. 1 illustrates a system 100 configured for building a highlight reel of a video game including clips of stored game plays of the video game that follow a mini story arc generated using generative artificial intelligence, in accordance with one embodiment of the present disclosure. In that manner, a user is able to learn about the video game in an enjoyable and efficient manner that is controlled by the user through requested settings and/or parameters, such as requested story class, duration of highlight reel, revealing spoilers or not revealing spoilers, etc.

In particular, system 100 includes a video game highlight service 120 that is configured to build the highlight reel of a video game. The video game highlight service may be remotely located, and in one implementation is implemented within a cloud game network 190 configured to provide gaming. In other implementations, the video game highlight service is a stand-alone service accessible over a network, or may be available at a client device. For ease of illustration, the video game highlight service is described within the cloud game network 190.

As shown, system 100 may provide gaming over a network 150 for one or more client devices 110. In particular, system 100 may be configured to enable users to interact with interaction applications, including provide gaming to users participating in a single-player or multi-player gaming sessions (e.g., participating in a video game in single-player or multi-player mode, or participating in a metaverse generated by an application with other users, etc.) via a cloud game network 190, wherein the game can be executed locally (e.g., on a local client device of a corresponding user) or can be executed remotely from a corresponding client device 110 (e.g., acting as a thin client) of a corresponding user that is playing the video game, in accordance with one embodiment of the present disclosure. For example, the cloud game network 190 supports a multi-player gaming session for a group of users, supports multiple users participating in a metaverse, etc.

In some embodiments, the cloud game network 190 may include a plurality of virtual machines (VMs) running on a hypervisor of a host machine, with one or more virtual machines configured to execute a game processor module utilizing the hardware resources available to the hypervisor of the host. It should be noted, that access services, such as providing access to games of the current embodiments, delivered over a wide geographical area often use cloud computing. Cloud computing is a style of computing in which dynamically scalable and often virtualized resources are provided as a service over the internet.

An application instance (e.g., video game) may be operating locally at a client device (e.g., gaming console, tablet, mobile phone, etc.), or remotely at a cloud game network, or some combination (e.g., thin client). For example, in a single-player session, the application instance may be executing locally with communication to the cloud game network 190 for additional services (e.g., storing game plays, supporting the video game highlight service, etc.). In another implementation of the single-player session, the application instance may be cloud based with a thin client for user interaction. In another example, a multi-player session allowing participation for a group of users to interact within a gaming world or metaverse generated by an application (which may be a video game), wherein some users may be executing an instance of the application locally on a client device (e.g., gaming console, tablet, mobile phone, etc.) to participate in the multi-player session. Other users in the multi-player session, who do not have the application installed on a selected device or when the selected device is not computationally powerful enough to executing the application, may be participating in the multi-player session via a cloud based instance of the application executing at the cloud game network 190.

As shown, the cloud game network 190 includes a game server 160 that provides access to a plurality of video games for single-player or multi-player gaming sessions. For example, most video games played in a corresponding multi-player session are played over the network 150 with connection to the game server 160. In particular, game server 160 may manage a virtual machine supporting a game processor that instantiates a cloud based instance of an application for a user. As such, a plurality of game processors of game server 160 associated with a plurality of virtual machines is configured to execute multiple instances of one or more applications associated with gameplays of a plurality of users. In that manner, back-end server support provides streaming of media (e.g., video, audio, etc.) of gameplays of a plurality of applications (e.g., video games, gaming applications, etc.) to a plurality of corresponding users. That is, game server 160 is configured to stream data (e.g., rendered images and/or frames of a corresponding gameplay) back to a corresponding client device 110 through network 150. As such, a computationally complex gaming application may be executing at the back-end server in response to controller inputs received and forwarded by client device 110. Each server is able to render images and/or frames that are then encoded (e.g., compressed) and streamed to the corresponding client device for display.

In at least one capacity, the cloud game network 190 supports a multi-player gaming session playing a video game or participating in a metaverse for a group of users, to include delivering and receiving game data of players for purposes of coordinating and/or aligning objects and actions of players within a scene of a gaming world or metaverse, managing communications between user, etc., so that the users in distributed locations can interact with each other in the gaming world or metaverse in real-time. For example, the multi-player session, for gaming or participating in a metaverse, involves multiple instances of an application (e.g., generating virtual environment, gaming world, metaverse, etc.), wherein a dedicated server application (session manager) collects data from users and distributes it to other users so that all instances are updated as to objects, characters, etc. to allow for real-time interaction within the virtual environment of the multi-player session.

In addition, the cloud game network 190 includes storage 180 configured for storing user generated content 182 and a list of playable events 410 (e.g., playable within a game play for a user) for a corresponding video game. In particular, the user generated content includes game plays of the corresponding video game by multiple players. For example, game plays are uploaded to the cloud game network 190 for storing as players are playing the video game. These game plays can be accessed to perform one or more services at a later time, such as extracting clips for purposes of populating highlight reels built using embodiments of the present disclosure.

Also, each of the playable events in the list of playable events 410 is predefined for the corresponding video game. That is, each playable event may be tagged with information generally identifying the playable event, and how that event fits within the construct or lore of the video game. As such, a particular moment in a game play of the video game by a player may be tagged with information corresponding to the playable event that the player is encountering. As such, various points in the game play of the player may be tagged and/or indexed with one or more playable events.

Further, the playable events in the list of playable events may be ordered according to an arc order for the corresponding video game. The arc order defines a logical construct within which playable events can occur in relation to each other. That is, each playable event may be indexed within the arc order. For instance, some playable events must occur in a logical order. As an illustration, key events are ordered such that a first key event precedes a second key event (e.g., a first child is born and appears within the video game before a second child is born, or a task cannot be performed until a weapon is first earned). Of course, other playable events may occur between two key events. In another instance, some events must occur between two identified events (e.g., key events, critical events, etc.), wherein these events may overlap with each other in occurrence between these two identified events, such that ordering of these events are not strict. However, the playable events between two identified events may occur before or after (following the arc order) other playable events that are performed between another two identified events. In still another instance, some events may occur at any point in the arc order. Other ordering of playable events are supported within the arc order.

Instances of an application may be executing locally on a client device 110 or at the cloud game network 190. In either case, the application as game logic 115 is executed by a game engine 111 (e.g., game title processing engine). For purposes of clarity and brevity, the implementation of game logic 115 and game engine 111 is described within the context of the cloud game network 190. In particular, the application may be executed by a distributed game title processing engine (referenced herein as “game engine”). In particular, game server 160 and/or the game title processing engine 111 includes basic processor based functions for executing the application and services associated with the application. For example, processor based functions include 2D or 3D rendering, physics, physics simulation, scripting, audio, animation, graphics processing, lighting, shading, rasterization, ray tracing, shadowing, culling, transformation, artificial intelligence, etc. In that manner, the game engines implement game logic, perform game calculations, physics, geometry transformations, rendering, lighting, shading, audio, as well as additional in-game or game-related services. In addition, services for the application include memory management, multi-thread management, quality of service (QoS), bandwidth testing, social networking, management of social friends, communication with social networks of friends, social utilities, communication channels, audio communication, texting, messaging, instant messaging, chat support, game play replay functions, help functions, etc.

In one embodiment, the cloud game network 190 may support artificial intelligence (AI) based services including, generative AI for generating content, and chatbot services (e.g., ChatGPT, etc.) that provide for one or more features, such as conversational communications, composition of written materiel, composition of music, answering questions, simulating a chat room, playing games, and others.

Users access the remote services with client devices 110, which include at least a CPU, a display and input/output (I/O). For example, users may access cloud game network 190 via communications network 150 using corresponding client devices 110 configured for providing input control, updating a session controller (e.g., delivering and/or receiving user game state data), receiving streaming media, etc. The client device 110 can be a personal computer (PC), a mobile phone, a personal digital assistant (PAD), handheld device, etc., and may be operating using different platforms, wherein each platform may include a combination of hardware and software components providing a set of capabilities in order to execute one or more software applications (e.g., video games).

In particular, client device 110 of a corresponding user is configured for requesting access to applications over a communications network 150, such as the internet, and for rendering for display images generated by a video game executed by the game server 160, wherein encoded images are delivered (i.e., streamed) to the client device 110 for display. For example, the user may be interacting through client device 110 with an instance of an application executing on a game processor of game server 160 using input commands to drive a gameplay. Client device 110 may receive input from various types of input devices, such as game controllers, tablet computers, keyboards, touch screens, gestures captured by video cameras, mice, touch pads, audio input, etc.

As previously introduced, client device 110 may be configured with a game title processing engine and game logic 115 (e.g., executable code) that is locally stored for at least some local processing of an application, and may be further utilized for receiving streaming content as generated by the application executing at a server, or for other content provided by back-end server support. In another embodiment, client device 110 may be configured as a thin client providing interfacing with a back end server (e.g., game server 160 of cloud game network 190) configured for providing computational functionality (e.g., including game title processing engine 111 executing game logic 115—i.e., executable code-implementing a corresponding application).

Client device 110 includes a video game highlight service interface 121 that is configured to communicate with the video game highlight service 120. For example, the interface 121 is separate from the game logic and game title processing engine, such that a user need not be using the client device to play video games, but instead wants to view highlight reels of video games.

Further, system 100 includes the video game highlight service 120 configured to build a highlight reel of a corresponding video game using stored game plays of the video game of various players. The video game highlight service may be implemented at the back-end cloud game network 190, or as a middle layer third party service that is remote from the client device. In some implementations, the video game highlight service may be located at a client device 110.

One or more features may be performed by the video game highlight service 120 using generative AI. For example, these features may be performed using artificial intelligence via an AI layer, wherein the AI layer may be implemented via one or more AI models 170 as executed by a deep/machine learning engine 195 of the video game highlight service 120 as controlled by each of the components of the video game highlight service. Each of the AI models perform customized classification and/or identification and/or generation of data. For example, the mini story arc engine 172 implements generative AI to generate a mini story arc of the corresponding video game. For example, the mini story arc is filled with selected playable events of the video game using artificial intelligence, wherein the playable events have been predefined. The clip identifier 176 implements generative AI to select clips of game plays of the video game stored in the cloud game network 190 as user generated content. Each of the selected clips corresponds with one of the predefined playable events filling the mini story arc. The highlight reel engine 320 is configured to implement generative AI to build the highlight reel according to user parameters, such as requested story class, and/or duration of the highlight reel, revealing spoilers or not revealing spoilers, etc. Further, the highlight reel is built based on the selected clips of user generated content. For example, the selected clips may be modified and ordered to follow the mini story arc to build the highlight reel.

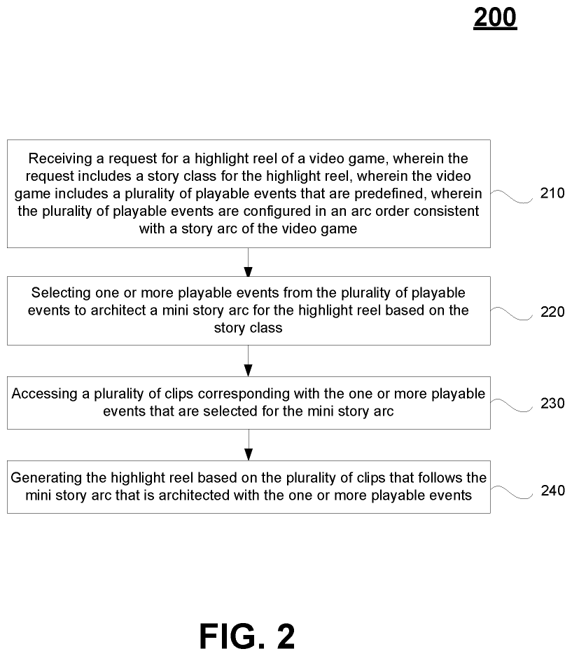

With the detailed description of the system 100 of FIG. 1, flow diagram 200 of FIG. 2 discloses a method for building a highlight reel of a video game including clips of stored game plays of the video game that follow a mini story arc generated using generative artificial intelligence, in accordance with one embodiment of the present disclosure. In that manner, a user is able to learn more about the video game in an enjoyable and efficient manner that is controlled by the user (e.g., requested story class, and/or duration of the highlight reel, revealing spoilers or not revealing spoilers, etc.). The operations performed in the flow diagram may be implemented by one or more of the entities previously described components, and also system 100 described in FIG. 1, including video game highlight service 120.

At 210, the method includes receiving a request for a highlight reel of a video game. The request may originate from a user, wherein the user may or may not have played the video game. The user may be interested in learning more of the game, such as the lore the game in its entirety, or in portions.

Further, the request includes a story class for the highlight reel, wherein the story class defines a complexity and/or duration of the highlight reel. In that manner, the user is able to provide some control for the generation of the highlight reel. For example, the story class may define a type of the highlight reel, wherein each successive type increases the complexity of the corresponding highlight reel. That is, each successive type provides more detail for the highlight reel than a preceding type of highlight reel. As an illustration, the video game includes a plurality of playable events that are playable by players in corresponding game plays. For example, two separate players may play a particular playable event differently. As such, the least complex story class or type of highlight reel provides the least amount of detail (e.g., interesting or important playable events, etc.) of the video game, whereas the most complex story class or type of highlight reel provides the most amount of detail for the video game. Other intervening story classes provide less detail than the most complex story class.

The story class may also define a time period or duration of the highlight reel. That is, the user may specify a duration for the highlight reel as a parameter when requesting the highlight reel. For example, the user may request that the highlight reel be limited to 3 minutes in duration. As such, the highlight reel would include less detail about the video game because the duration is short, but would still provide interesting and/or important events occurring in the game play of the video game. The user may also request that the highlight reel be of longer duration, such as 10 minutes. Because more time is requested by the user, more detail may be provided in the highlight reel. As such, more of the lore of the video game may be told within the highlight reel. The user may also request that the highlight reel be an hour, or longer. For example, the user may want a highlight reel that tells the entire lore of the video game.

In another embodiment, the story class may define a limited period within a game play of the video game. That is, the mini story arc told in the highlight reel is limited to within a specific period of the video game. For example, the highlight reel may be limited to show details of a particular level of the video game, or a specific time period within the game play (e.g., after a first playable event and/or before a second playable event).

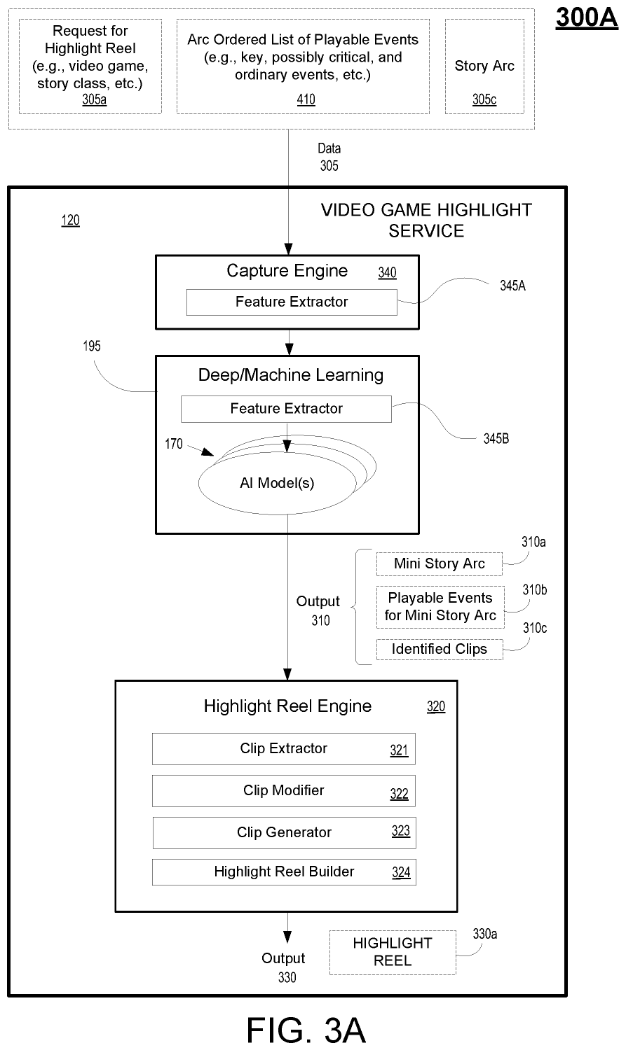

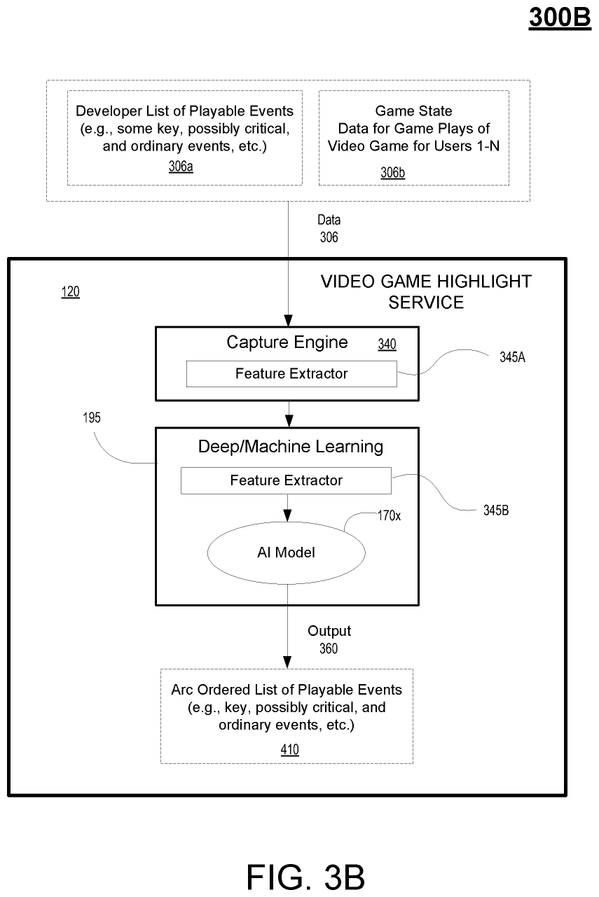

As previously described, each of the plurality of playable events is predefined. That is, each playable event is identified (e.g., tagged with information). In one embodiment, one or more of the plurality of playable events is identified and tagged during development of the video game. That is, the developer can identify playable events. These events can be tagged with identifying information within the video game. In another embodiment, one or more of the plurality of playable events is identified using artificial intelligence. This process of using AI to identify playable events is more fully described in FIG. 3B.

Playable events that are predefined may be categorized based on levels of importance. For example, a key event category includes playable events that are highly important, and/or required within the story arc or lore of the video game. Also, a critical event category includes playable events that are important and/or required for the mini story arc of the highlight reel. That is, critical playable events are descriptive of the lore being told within the highlight reel. The value of the critical playable event may be different when considered within a corresponding highlight reel versus within the entire lore of the video game. For instance, while a critical playable event is important for telling the lore of the highlight reel, that critical playable event may not be important within the entire lore of the video game. Of course, some critical playable events are highly important both in telling the lore of the highlight reel, and for telling the lore of the video game. Further, an ordinary event category includes ordinary events that may not hold that much importance. For example, an ordinary event may link a first playable event to a second playable event. That is, an ordinary event may include walking between buildings, or walking or spending time between two playable events.

As previously described, the plurality of playable events is configured in an arc order that is consistent with a story arc for the video game. The story arc expresses the lore of the video game, and playable events are intended to be performed to fit within the story arc. As such, playable events can be indexed against other playable events, so that each event can be ordered to fit within the construct or lore of the video game. For example, key playable events are performed in order, and other less important playable events may be performed between two key playable events. For instance, one key playable event could be when a character has a child. Other playable events involving the child would have to occur or be performed after the child is born, and defines the arc order of those playable events. Still other playable events may be performed at any time (e.g., ordinary playable events). Other playable events may overlap each other in the arc order, such as playable events that can occur at any time between two identified playable events. Still other ordering of playable events within the arc order are supported.

At 220, the method includes selecting one or more playable events from the plurality of playable events to architect a mini story arc for the highlight reel based on the story class. For example, the mini story arc engine 172 of the video game highlight service may be configured to generate the mini story arc, which tells the lore of the highlight reel. In one implementation, the mini story arc engine 172 employs an AI model implementing generative AI to generate the mini story arc of the highlight reel. In particular, input to a deep learning engine via the AI model includes the plurality of playable events, the arc order, and the story class for the highlight reel. Through the AI model, generative artificial intelligence is implemented by the deep learning engine to architect the mini story arc. That is, the mini story arc is architected with one or more playable events, that are predefined. For instance, the mini story arc provides an outline of one or more playable events that are sequentially ordered.

At 230, the method includes accessing a plurality of clips corresponding with the one or more playable events that are selected and/or identified when architecting the mini story arc of the highlight reel. For example, the clip identifier 176 is configured to identify and access clips of user generated content including game plays of players playing the video game. In one implementation, the clip identifier employs an AI model implementing generative AI to select clips of user generated content. In particular, input to a deep learning engine via the AI model includes the one or more playable events, previously identified, and a plurality of user generated content of one or more game plays of one or more users playing the video game. For example, a sufficient number of one or more game plays is necessary for sampling and analysis by the AI model. In implementations, the user generated content is recorded and stored by a proprietary gaming service, configured to provide gaming access to the video game, as well as other video games, or through a third party source (e.g., social media, etc.). Through the AI model, generative AI is implemented by the deep learning engine for selecting the plurality of clips corresponding with the one or more predefined playable events that are selected to architect the mini story arc.

At 240, the method includes generating the highlight reel based on the plurality of clips that follows the mini story arc architected with one or more playable events. For example, the highlight reel engine 320 is configured to build the highlight reel. In one implementation, the highlight reel engine employs an AI model implementing generative AI to build the highlight reel according to user parameters, such as requested story class, and/or duration of the highlight reel, and/or revealing spoilers or not revealing spoilers, etc. Further, the highlight reel is built based on the selected clips of user generated content. In particular, input to a deep learning engine via the AI model includes the mini arc story as architected with playable events, clips of user generated content, and the user parameters. For example, when building the highlight reel, the selected clips may be modified and ordered to follow the mini story arc.

FIG. 3A is an illustration of a system configured to implement one or more artificial intelligence models configured for generating a mini story arc of the video game, filling the mini story arc with playable events in the video game, and selecting clips of stored game plays of the video game that follow the mini story arc that are modified and ordered to build a highlight reel of the video game, in accordance with one embodiment of the present disclosure. For purposes of illustration, the system of FIG. 3A may be implemented by the cloud game network 190 or the client device 110 of FIG. 1, or a combination thereof. Further, the system may be implemented through a third party or mid-level video game highlight service communicatively coupled through a network.

Data 305 is captured and/or provided to the video game highlight service 120 for purposes of building a highlight reel of a corresponding video game based on stored game play of the video game of various players. In particular, data 305 includes a request 305a for the highlight reel of the video game, a list of playable events 410 of the video game, and a story arc 305c of the video game. One or more features are generated from the data 305 using one or more components of the video game highlight service that implement generative AI using corresponding AI models.

The request 305a from a user includes an identification of the video game for which the highlight reel is generated, and a story class of the highlight reel. As previously described, the story class defines a complexity and/or duration of the highlight reel. For example, the user may request a highlight reel that provides a quick summary of the video game, such that the story class may be less complex and indicates that the highlight reel should provide a minimum amount of detail of the video game. In another example, the user may request a full summary of the video game, such that the story class may be quite complex, and indicates that the highlight reel provide a copious amount of detail for the video game. Still other story classes are supported, such that varying degrees of detail and/or complexity is provided in the highlight reel. The story class may be defined by a duration requested by the user. As such, the requested duration may set the complexity of and/or the amount of detail provided in the highlight reel. For instance, a duration of less than 10 minutes would indicate that the user requests a quick summary of the video game with a minimum amount of detail, whereas a requested duration of 10-20 minutes indicates that the highlight reel include a moderate amount of detail, and a duration of over 20 minutes indicates that the highlight reel include a maximum amount of detail. Also, the story class may define a limited period in the video game, such that the highlight reel focuses on playable events performed during this limited period (e.g., game play between two identified events, a level, a boss fight, a task, etc.).

Capture engine 340 of the video game highlight service 120 may be configured to receive data 305 (e.g., through internal and/or external networks) and capture and/or receive any data that is relevant to building the highlight reel for the corresponding video game. In particular, depending on the output required, capture engine 340 is configured to capture and then provide the captured data as input into a corresponding AI model (taken from one of the AI models 170) for purposes of classifying and/or identifying and/or generating output 310. For example, selected portions of data 305 may be analyzed by feature extractor 345A to extract out the salient and/or relevant features useful in building the highlight reel. In some implementations, feature definition and extraction is performed by the deep/machine learning engine 195, such that feature learning and extraction is performed internally, such as within the feature extractor 345B.

For example, the capture engine 340, in cooperation with or as directed by the mini story arc engine 172, is configured to analyze data 305 and capture and/or receive as input any data (i.e., features) that may be used for generating a mini story arc or lore of the highlight reel. In particular, the feature extractor may be configured to learn and/or define features (e.g., lore of the video game, story class, duration, other user parameters, etc.) that are associated with developing a lore within the parameters set by the user in the request for a highlight reel. The features are provided as input into a corresponding AI model for classification and/or generation of the mini story arc 310a that is provided as output 310.

In addition, the capture engine 340, in cooperation with or as directed by the playable events identifier 174, is configured to analyze data 305 and capture and/or receive as input any data (i.e., features) that may be used for identifying playable events in the video game for use in the mini story arc. In particular, the feature extractor may be configured to learn and/or define features (e.g., lore of the video game, mini story arc, identification and/or classification of playable events, etc.) that are associated with identifying playable events that are used to architect the mini story arc. The features are provided as input in a corresponding AI model for classification and/or identification of the playable events, and an order of those playable events (i.e., mini arc order) used for telling the lore of the mini story arc. In general, the mini arc order of the playable events in the mini story arc is consistent with the arc order of the video game, as previously described. Further, an allotted time may be determined for each of the playable events, such that when all of the allotted times for the playable events are combined, it equals the duration of the highlight reel.

Further, the capture engine 340, in cooperation with or as directed by the clip identifier 176, is configured to analyze data 305 and capture and/or receive as input any data (i.e., features) that may be used for classifying and/or identifying clips of game plays of the video game from various players that corresponding with the previously classified playable events used for the mini story arc of the highlight reel. In particular, the feature extractor may be configured to learn and/or define features (e.g., identified events within game plays of the video game from various players, lore of the video game, mini story arc, identification and/or classification of playable events, etc.) that are associated with selecting clips that correspond with playable events used in the mini story arc. The features are provided as input in a corresponding AI model for classification and/or identification of the clips of game plays of various players that corresponding with the playable events used for telling the lore of the mini story arc.

As shown, the deep/machine learning engine 195 is configured for implementation of one or more AI models configured to classify and/or identify and/or generate a mini story arc 310a, one or more playable events 310b that are used to architect the mini story arc, and one or more identified clips 310c corresponding with the playable events used to architect the mini story arc when building the highlight reel of the corresponding video game.

For example, different AI models are used to classify/identify/generate one or more of the mini story arc 310a, one or more playable events 310b, and/or one or more identified clips 310c. In one embodiment, a corresponding one of the AI models 170 is a machine learning model configured to apply machine learning. In another embodiment, a corresponding one of the AI models 170 is a deep learning model configured to apply deep learning, wherein machine learning is a sub-class of artificial intelligence, and deep learning is a sub-class of machine learning. These classifications and/or identifications and/or generated data are provided as output 310.

Purely for illustration, the deep/machine learning engine 195 may be configured as a neural network used to implement one or more of the AI models 170, in accordance with one embodiment of the disclosure. Generally, the neural network represents a network of interconnected nodes responding to input (e.g., extracted features) and generating an output, such as those identified above. In one implementation, the AI neural network includes a hierarchy of nodes. For example, there may be an input layer of nodes, an output layer of nodes, and intermediate or hidden layers of nodes. Input nodes are interconnected to hidden nodes in the hidden layers, and hidden nodes are interconnected to output nodes.

Interconnections between nodes may have numerical weights that may be used link multiple nodes together between an input and output, such as when defining rules of one of the AI models 170.

In particular, an AI model is configured to apply rules defining relationships between features and outputs (e.g., a player's gaming effectiveness when playing a video game, etc.), wherein features may be defined within one or more nodes that are located at one or more hierarchical levels of the AI model. The rules link features (as defined by the nodes) between the layers of the hierarchy, such that a given input set of data leads to a particular output (e.g., a mini arc story of a video game, playable events to architect the mini arc story, and clips of game plays of the video game that correspond with the playable events) of the AI model. For example, a rule may link (e.g., using relationship parameters including weights) one or more features or nodes throughout the AI model (e.g., in the hierarchical levels) between an input and an output, such that one or more features make a rule that is learned through training of the AI model. That is, each feature may be linked with one or more features at other layers, wherein one or more relationship parameters (e.g., weights) define interconnections between features at other layers of the AI model. As such, each rule or set of rules corresponds to a classified output. In that manner, the resulting output 310 according to the rules of the AI model 170 may classify and/or label and/or identify and/or generate a mini story arc 310a, one or more playable events 310b, and/or one or more identified clips 310c.

The output 310 is provided to the highlight reel engine 320. In particular, at least the mini story arc 310a, one or more playable events 310b, and/or one or more identified clips 310c are provided as input to the highlight reel engine. In one embodiment, artificial intelligence is not used by the highlight reel engine when assembling the highlight reel. In that manner, hallucinations within the highlight reel can be avoided as the highlight reel is built using clips of game plays of the video game of one or more players. In another embodiment, artificial intelligence can be used, in part, by the highlight reel engine when assembling the highlight reel.

In particular, the clip extractor 321 of the highlight reel engine 320 is configured to access each of the identified clips 310c. For example, clips can be accessed from a proprietary cloud game network, wherein the video game is played in collaboration with a particular cloud game network. For example, the cloud game network has ownership rights or exclusive licensing to the video game. In that manner, the corresponding game plays can be stored in collaboration with or at the cloud game network. In another example, clips can be accessed from a third party source. that is, one or more game plays of the video game can be stored across one or more third party sources.

Also, the clip modifier 322 of the highlight reel engine 320 is configured to modify a corresponding clip to fit when architecting the mini arc story. For example, the clip may be 5 minutes in length, but the corresponding playable event is allotted 15-20 seconds. As such, the clip modifier selects the portion of the clip that best fits within the allotted time, or combines one or more portions of the clip to fit within the allotted time for inclusion in the highlight reel.

In still another embodiment, the clip generator 323 of the highlight reel engine 320 is configured to generate a clip of the video game that is fills in a corresponding playable event used to architect a portion of the highlight reel. For example, when the game is relatively new, there may be an insufficient number of game plays of the video game. In that case, not every playable event of a video game may have been encountered within any game play, especially a video game that is based on an open world. In another example, the generated clip may link two playable events within the highlight reel, such as when a character is walking from one location to another location within the gaming environment of the video game. There may not be any clips of game plays of the video game that include the walking between two locations, or it may be more efficient to generating the walking sequence rather than searching for a walking sequence in the vast amount of game plays of the video game. In that case, the clip generator 323 works in conjunction with a game title processing engine, used for executing the game logic of the video game, to generate the walking sequence of the clip.

The highlight reel builder 324 is configured to build the highlight reel based on the mini arc story that is architected with playable events, and based on the stored clips of those playable events that possibly have been modified or newly generated clips of those playable events. For example, the clips are concatenated and blended to architect the mini story arc of the highlight reel. That is, the highlight reel engine 320 is configured to provide an output 330, which in one implementation is the highlight reel 330a. Because clips of game play of the video game are used to build the highlight reel, hallucinations from content generated using artificial intelligence can be minimized or eliminated.

FIG. 3B is an illustration of a system 300B configured to implement an artificial intelligence model configured for generating a list of playable events that occur in a video game, in accordance with one embodiment of the present disclosure. In addition, the AI model may be configured to generate an arc order corresponding to the lore of the video game, wherein the playable events are positioned within the arc order. The system of FIG. 3B may be implemented through a cloud game network, or a third party, or a mid-level video game highlight service communicatively coupled through a network.

Data 306 is captured and provided to the video game highlight service 120 for purposes of identifying playable events that can occur in the video game. In particular, data 306 includes developer list of playable events 306a. That is, the developer of the video game may identify at least one playable event within the video game, which can be included in the final list of playable events for the video game without further analysis.

In addition, data 306 includes gaming information related to game plays of the video game for one or more players. Specifically, data 306 includes game state data 306b for each of the game plays of the video game by one or more players. The game plays may be collected and/or continually monitored. That is, game state may be from a game play of a video game at a particular point in time, or a state of an application during execution, wherein game state data allows for the generation of the gaming environment at the corresponding point in the game play. Also, game state data may include states of devices used for rendering the game play (e.g., states of the CPU, GPU, memory, register values, etc.), platform device information, identification of the executable code to execute the video game at that point, game characters, game objects, object and/or game attributes, graphic overlays, and other information. Also, metadata may include information describing the game context of a particular point in the game play of the user, or the metadata may be used to determine game context, such as where in the game the user is, type of game, mood of the game, rating of game (e.g., maturity level), the number of other players there are in the gaming environment, game dimension displayed, which players are playing a particular gaming session, descriptive information, game title, game title version, franchise, format of game title distribution, downloadable content accessed, links, credits, achievements, awards, trophies, and other information.

Capture engine 340 of the video game highlight service 120 may be configured to receive data 305 and capture and/or receive any data that is relevant to classifying and/or identifying playable events found within the corresponding video game. In particular, a plurality of features is extracted from the plurality of game plays, wherein the plurality of features is related to one or more playable events occurring in the plurality of game plays. For example, selected portions of data 306 may be analyzed by feature extractor 345A of the capture engine to extract out the salient and/or relevant features useful in classifying and/or identifying playable events within the video game. That is, the feature extractor is configured to learn and/or define features that are associated with playable events within the video game. In some implementations, feature definition and extraction is performed by the deep/machine learning engine 195, such that feature learning and extraction is performed internally, such as within the feature extractor 345B.

The features are provided as input into a corresponding AI model 170x for classification and/or identification of the playable events of the video game, which is provided as output 360. Furthermore, the AI model may be configured to list the playable events in an arc order for the video game, wherein the arc order defines a logical construct within which playable events can occur in relation to each other, such that playable events may be indexed within the arc order. For example, in the arc order, key events are sequentially ordered (e.g., events involving a child must occur after the child is born), critical events that may be important to the video game, and ordinary events that can occur at any time or between at least two identified events. Critical and/or ordinary events may overlap with each other in occurrence, such that the ordering of these events are not strict.

As previously described, in one embodiment, AI model 170x is a machine learning model configured to apply machine learning. In another embodiment, AI model 170x is a deep learning model configured to apply deep learning, wherein machine learning is a sub-class of artificial intelligence, and deep learning is a sub-class of machine learning. In particular, the AI model 170x may be configured as a neural network of interconnected nodes that respond to the input (e.g., features) and generate an output that classifies and/or identifies the playable events within the video game. That is, the AI model applies rules defining relationships between features and outputs, wherein the rules link features between layers of the hierarchy. In that manner, the resulting output 360 according to the rules of the AI model 170x may classify and/or label and/or identify an arc ordered list of playable events 410, which was previously introduced. In addition, the arc ordered list of playable events may include the developer list of playable events 306a.

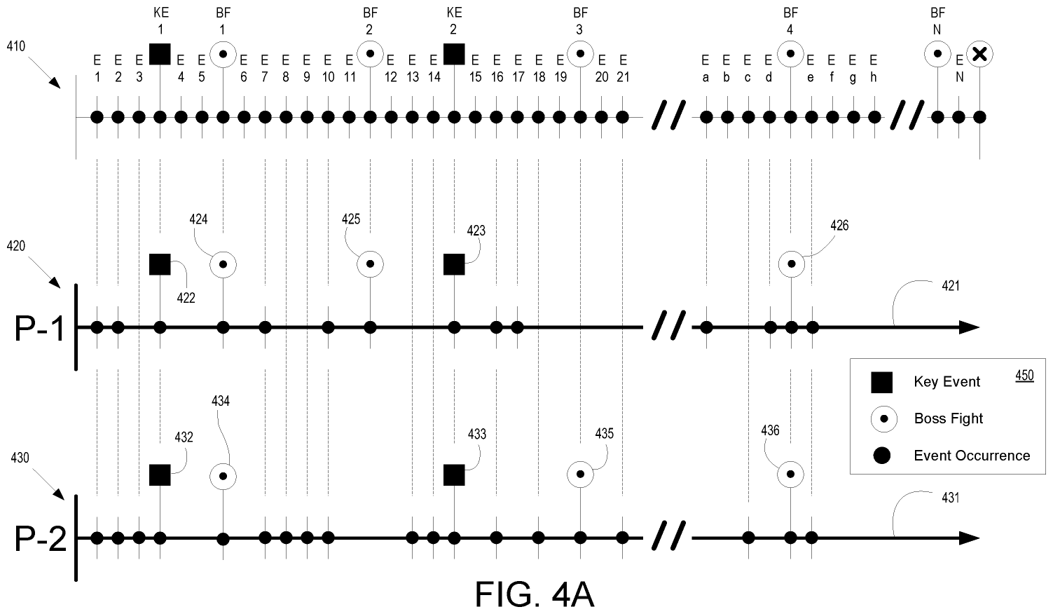

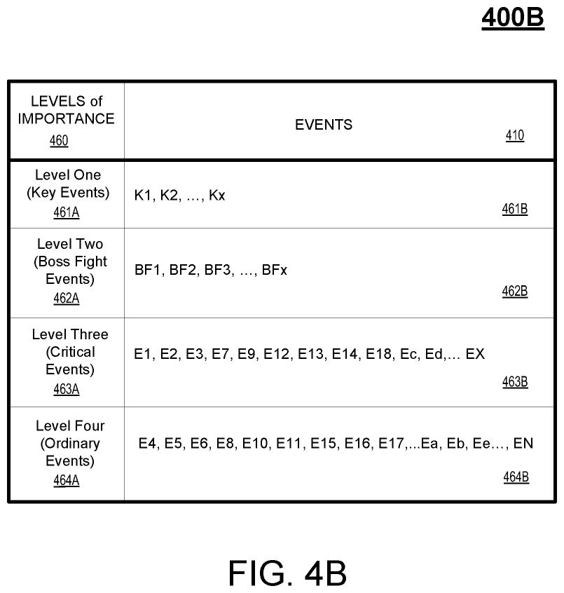

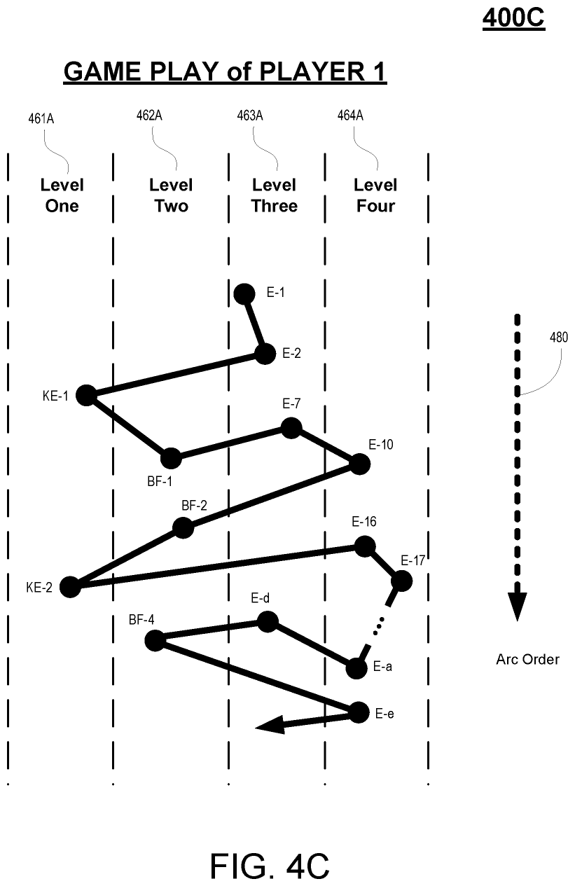

FIG. 4A is an exemplary illustration of the list of playable events 410, arranged in arc order, for a corresponding video game, in accordance with one embodiment of the present disclosure. Playable events in the list 410 are shown according to key 450, which includes symbols for various types of playable events. For example, a solid block is representative of a key event. A bullseye represents a boss fight, which may be a critical event and/or a key event. The solid circle represents an event occurrence, which may be a critical event or an ordinary event.

Playable events in the list 410 may be arranged in an arc order that defines a logical construct within which playable events can occur in relation to each other, such that playable events may be indexed within the arc order, as previously described. Playable events are shown in some order, for purposes of illustration. As such, playable events in list 410 may be numbered in sequence which provides some ordering, though the ordering may not necessarily be strictly applied. For instance, some playable events may overlap, or may occur before or after another playable event. During a corresponding game play of the video game, not all playable events are performed. In that manner, each game play is unique with regards to the playable events that are performed and how they are performed.

In particular, key events may occur sequentially with respect to each other (i.e., between key events) in the arc order (KE1, then KE2, etc.), as previously described. For example, one key event may be the birth of a child, and a subsequent key event including a birthday that celebrates adulthood of the child would occur after the birth of the child. Boss fights are generally important events within the video game and may be categorized as key events that must occur in some order. As such, these boss fights occur within the sequential order of key events. Also, some boss fights may not be categorized as a key event, and as such may occur at any point in the game play of the video game, or may be restricted to occur between two or more playable events, though these boss fights are equally important in the video game. For example, boss fight 2 (BF2) may occur before or after boss fight 3 (BF3), or may occur before or after boss fight 4 (BF4). Critical events may be important for a highlight reel, and within the construct of the video game. That is, critical events may be important for a particular period of the video game, such as when telling the lore between two key events. In that case, critical events occur between two or more key events, but may occur in any order between those key events. For example, critical events E7, E9, and E12 must occur between key event 1 (KE1) and key event 2 (KE2), but may occur in any order between those two key events. However, critical events may not necessarily be important within the full context of the video game. That is, certain critical events may not be included as they are not that important when telling the lore of the full video game. Generally, ordinary playable events may occur at any point within the video game. In some implementations, ordinary playable events must occur before another playable event, or occur in sequence, or must occur between at least two identified events. Other conditions of the ordering of playable events (e.g., key events, boss fights, critical events, ordinary events, etc.) are supported.

The playable events in list 410 may be categorized in order of importance. For example, FIG. 4B is an illustration of the list of playable events introduced in FIG. 3B that are categorized and/or ranked according to one or more levels of importance, in accordance with one embodiment of the present disclosure. There may be one or more levels, with varying degrees of importance and labeling. As shown, one or more levels 460 define one or more categories of importance. Playable events are also listed for each level, wherein the playable events follow the arc order. For instance, level one (461A) includes key events, with corresponding playable events shown in a list of key events 461B (e.g., K1, K2, . . . and Kx). Level two (462A) includes boss fight events, with corresponding playable events shown in a list of boss fight events 462B (e.g., BF1, BF2, BF3, . . . and BFx). Level three (463A) includes critical events, with corresponding playable events shown in a list of critical events 463B (e.g., E1, E2, E3, E7, E9, E12, E13, E14, E18, Ec, Ed, . . . and EX). Critical events may be important for telling a lore of any potential highlight reel that is being generated. Level four (464A) includes ordinary events, with corresponding playable events shown in a list of ordinary events 464B (e.g., E4, E5, E6, E8, E10, E11, E15, E16, E17, . . . . Ea, Eb, Ee, . . . and EN). Ordinary events have low importance, such as a playable event that connects two key or critical events (e.g., walking between two locations in the gaming environment).

Players that play the video game interact with one or more playable events in the list 410. For example, the game play of player P-1 includes playable events arranged in sequential order of performance in the list of playable events 420. Also, the game play of player P-2 includes playable events arranged in sequential order of performance in the list of playable events 430. For example, player P-1 performs the playable events in list 420 in sequential order on timeline 421, to include critical events “E1” and “E2”; key event 1 (KE1) shown by block 422, boss fight 1 (BF1) shown by bullseye 424, critical event “E7”, ordinary event “E10”, boss fight 2 (BF2) shown by bullseye 425, key event 2 (KE2) shown by block 423, ordinary events “E16” and “E17”, . . . ordinary event “Ea”, critical event “Ed”, boss fight 4 (BF4) shown by bullseye 426, and ordinary event “Ee”.

For visualization, FIG. 4C is a chart 400C illustrating the game play of player P1, and includes one or more playable events arranged sequentially as they are performed, in accordance with one embodiment of the present disclosure. Further, the playable events are arranged by categories of importance shown in FIG. 2, such that the playable events are categorized according to corresponding levels of performance, in accordance with one embodiment of the present disclosure. For purposes of illustration, four categories of importance are shown, and include level one 461A, level two 462a, level three 463A, and level four 464A. For example, playable events in the game play of player P-1 include performing playable events in level three (E1 and E2), and then performing a playable event at level one (KE1), and then performing a playable event at level two (boss fight 1-BF1), etc. The playable events comply with the defined arc order 480 for the video game, as previously described. For example, critical event E7 and ordinary event E10 may be conditioned upon being performed between two identified events (e.g., level two boss fight 1—BF1 and boss fight 2—(BF2)). As shown, player P2 first performs level two, boss fight 1 (BF1); and then performs critical event E7 (level 3); and then performs ordinary event E10 (level 4); and finally performs level two, boss fight 2 (BF2).

Also, player P-2 performs the following playable events in sequential order on timeline 431, to include critical events “E1” and “E2” and “E3”, key event 1 (KE1) shown by block 432, boss fight 1 (BF1) shown by bullseye 434, critical event “E7”, ordinary event “E8”, critical event “E9”, ordinary event “E10”, crucial events “E13” and “E14”, key event 2 (KE2) shown by block 433, ordinary event “E16”, critical event “E18”, boss fight 3 (BF3) shown by bullseye 435, . . . critical event “Ec”, boss fight 4 (BF4) shown by bullseye 436, and ordinary “Ee”.

As previously described, during a corresponding game play of the video game, not all playable events are performed. For example, both players P-1 and P-2 perform boss fight 1 (BF1), but only player P-1 performs boss fight 2 (BF2) (i.e., player P-2 passes on BF2).

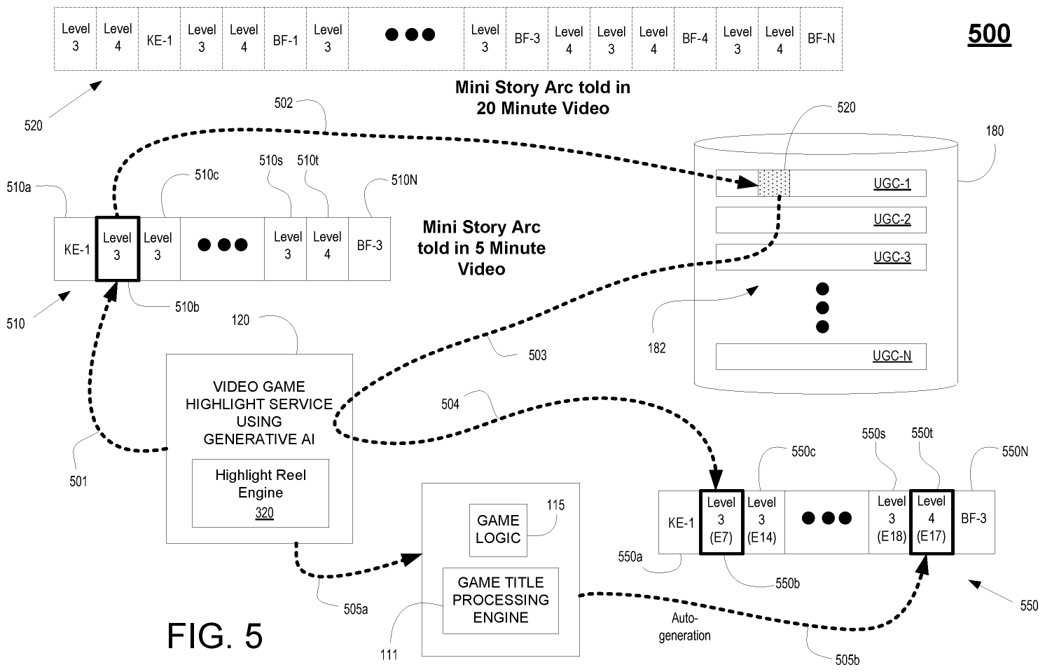

FIG. 5 is a data flow diagram 500 illustrating the selection of stored game plays of a video game or dynamic generation of game play of the video game that are modified and ordered to build a highlight reel of the video game, in accordance with one embodiment of the present disclosure. The highlight reel is a collapsed version of the entire lore for the story arc of the video game. The highlight reel is generated by the video game highlight service 120 using generative AI. For example, a request for the highlight reel 550 is processed by service 120 to generate a highlight reel as an output. The request may include a story class defining user parameters, such as duration. For purposes of illustration, the data flow is described for building the highlight reel 510 of a short duration.

Highlight reel 550 is of short duration (e.g., 5 minutes) and includes a mini story arc 510 that is consistent with a story arc for the video game. For example, the mini story arc is architected with a plurality of playable events by the video game highlight service 120, as is shown in leg 501 of the data flow. The playable events may be characterized by categories (or levels) of importance, such as those in FIG. 4B. The architecture may provide an outline for the mini story arc, and include slots where categories (or levels) of playable events and/or specific references to playable events are ordered. When only a category is provided as a first step, the video game highlight service selects an appropriate playable event in the same or following step.

In particular, the mini story arc 510 of highlight reel 510 includes key event 1 (KE1) in the first slot (510a), that is then followed by two playable events of level 3 in slot 510b and slot 510c, . . . and then a level 3 playable event in slot 510s, and then a level 4 playable event in slot 510t, that is then followed by boss fight 3 (BF3) in slot 510N. In one embodiment, the outline of the mini story arc is more detailed, and includes a specific playable event for a corresponding level of playable event. For instance, the level 3 event in slot 510b may include a specific reference to playable event 7 (E7), which may be a critical event; also slot 510c references playable event 14 (E14)—a critical event; slot 510s references playable event 18 (E18)—a critical event; and slot 510t references playable event E17—an ordinary event.

In the second leg 502 of the data flow, the video game highlight service 120 selects one or more clips of game plays of one or more players, wherein each selected clip corresponds with a playable event architecting the mini story arc 510 of the highlight reel 550. For example, the clips may be accessed from storage 180, which may be a proprietary service provided by a proprietary game cloud network that owns rights to the corresponding video game, or may be a third party service storing video clips of game plays of one or more video games. In particular, storage 180 includes user generated content (UGC) 182 of game plays of the video game, such as UGC-1, UGC-2, UGC-3, . . . and UGC-N of one or more players. It is understood that storage 180 may store game plays of players playing a variety of video games.

For ease of understanding and clarity, only the process for accessing the clip for the playable event in slot 510b is shown. In particular, slot 510b references playable event E7, which is identified as occurring in UGC-1. As such, the corresponding clip 520 for playable event E7 is accessed from UGC-1.

In addition, clip 520 may be modified by the video game highlight service 120, as is shown in leg 503 of the data flow. Modification may be performed using artificial intelligence, in one embodiment. For example, clip 520 may be reduced in duration to fit within the time slot allotted for that playable event E7 within the highlight reel 550. Also, various portions of clip 520 may be selected to focus in on important features of playable event E7.

Thereafter, in leg 504, the clip 520 that is modified is placed into the highlight reel 550. For example, each of the clips that may be modified, are arranged and blended to fit within the highlight reel 550. For example, highlight reel 550 includes one or more clips, that may have been modified, as arranged in the allotted time slots of highlight reel 550, including a clip of key event 1 (KE1) in slot 550a, a clip of playable event E7 in slot 550b, a clip of playable event E14 in slot 550s, . . . , a clip of playable event E18 in slot 550t, and a clip of boss fight 3 (BF3) in slot 550N.

Further, not all the playable events in the architected mini story arc 510 may be available in the UGC 182, as previously described. In that case, the highlight reel engine 320 is configured to generate a clip for the corresponding playable event that cannot be found in game plays of storage 180, or that are unsatisfactory. For instance, playable event E17 may be unsatisfactory or not found in storage 180. In particular, in leg 505a of data flow, the highlight reel engine 320 instructs the game title processing engine 111 executing the game logic 115 corresponding to the video game to generate the clip of the corresponding playable event E17. As shown, in leg 505b of data flow, the clip of the corresponding playable event E17, that may have been modified, is then blended and inserted into the highlight reel 550 in slot 550N.

If the request calls for a story class of longer duration, highlight reel 520 may be generated that is of medium duration (i.e., 20 minutes). For example, the user may like the highlight reel 550 that is 5 minutes long, and requests a longer highlight reel 520. In another example, the request initially includes a story class for a highlight reel of 20 minutes. In particular, highlight reel 520 includes a separate mini story arc that provides more detail than the mini story arc of highlight reel 510. For instance, one or more interesting playable events may now be included in the longer highlight reel 520. One or more of the playable events between highlight reels 510 and 520 may overlap in usage. For example, the mini story arc of highlight reel 520 includes a plurality of playable events. The architecture may provide an outline for the mini story arc, and include slots where categories of playable events are ordered. Specifically, the mini story arc starts with a level 3 playable event; and then a level 4 playable event; and then key event 1 (KE1); followed by a level 3 playable event; followed by a level 4 playable event; and then boss fight 1 (BF1); and the a level 3 playable event; . . . another level 3 playable event; and then boss fight 3 (BF3); level 4 and then level 3 and then level 4 playable events; boss fight 4 (BF4) and then a level 3 playable event; and then a level 4 playable event; and then a final boss fight (BFN).

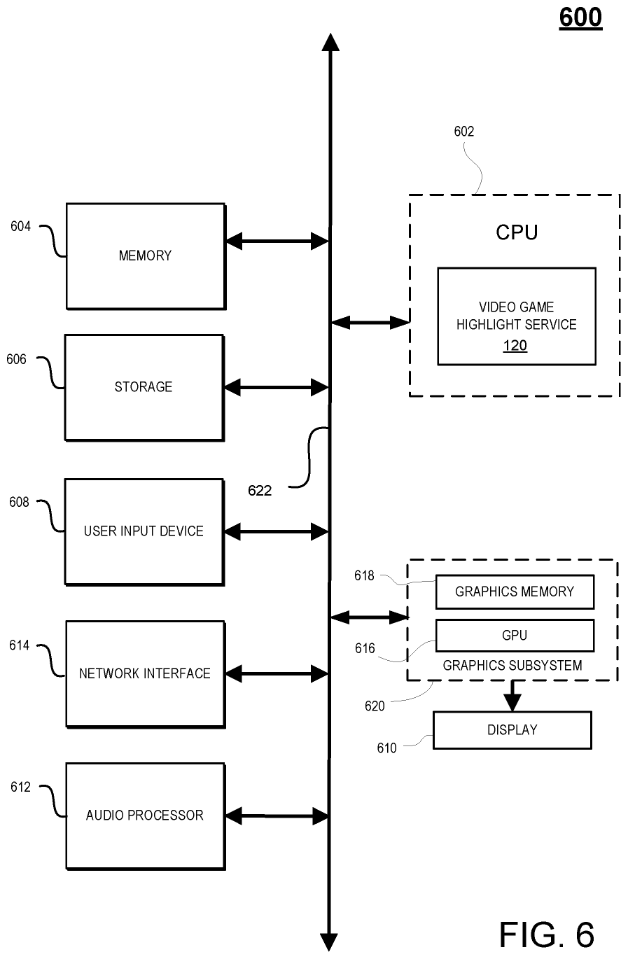

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, and includes a central processing unit (CPU) 602 for running software applications and optionally an operating system. CPU 602 may be comprised of one or more homogeneous or heterogeneous processing cores. Further embodiments can be implemented using one or more CPUs with microprocessor architectures specifically adapted for highly parallel and computationally intensive applications.

In particular, CPU 602 may be configured to implement a video game highlight service 120 that is configured to implement one or more artificial intelligence models that are configured for generating a mini story arc of the video game, filling the mini story arc with playable events in the video game, and selecting clips of stored game plays of the video game that follow the mini story arc that are modified and ordered to build a highlight reel of the video game. In that manner, a user is able to learn more about the video game in an enjoyable and efficient manner that is controlled by the user (e.g., requested story class, and/or duration of the highlight reel, revealing spoilers or not revealing spoilers, etc.).

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs. In one embodiment, GPU 616 may be implemented within an AI engine (e.g., machine learning engine 195) to provide additional processing power, such as for the AI, machine learning functionality, or deep learning functionality, etc.

The graphics subsystem 620 periodically outputs pixel data for an image from graphics memory 618 to be displayed on display device 610. Display device 610 can be any device capable of displaying visual information in response to a signal from the device 600.

In other embodiments, the graphics subsystem 620 includes multiple GPU devices, which are combined to perform graphics processing for a single application that is executing on a CPU. For example, the multiple GPUs can perform alternate forms of frame rendering, including different GPUs rendering different frames and at different times, different GPUs performing different shader operations, having a master GPU perform main rendering and compositing of outputs from slave GPUs performing selected shader functions (e.g., smoke, river, etc.), different GPUs rendering different objects or parts of scene, etc. In the above embodiments and implementations, these operations could be performed in the same frame period (simultaneously in parallel), or in different frame periods (sequentially in parallel).

Accordingly, in various embodiments the present disclosure describes systems and methods configured for building a highlight reel of a video game using stored game plays of the video game of various players, wherein generative AI is implemented to build a highlight reel of a video game including clips of stored game plays of the video game that follow a mini story arc.

It should be noted, that access services, such as providing access to games of the current embodiments, delivered over a wide geographical area often use cloud computing. Cloud computing is a style of computing in which dynamically scalable and often virtualized resources are provided as a service over the Internet. For example, cloud computing services often provide common applications (e.g., video games) online that are accessed from a web browser, while the software and data are stored on the servers in the cloud.

A game server may be used to perform operations for video game players playing video games over the internet, in some embodiments. In a multiplayer gaming session, a dedicated server application collects data from players and distributes it to other players. The video game may be executed by a distributed game engine including a plurality of processing entities (PEs) acting as nodes, such that each PE executes a functional segment of a given game engine that the video game runs on. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. The PEs may be virtualized by a hypervisor of a particular server, or the PEs may reside on different server units of a data center. Respective processing entities for performing the operations may be a server unit, a virtual machine, or a container, GPU, CPU, depending on the needs of each game engine segment. By distributing the game engine, the game engine is provided with elastic computing properties that are not bound by the capabilities of a physical server unit. Instead, the game engine, when needed, is provisioned with more or fewer compute nodes to meet the demands of the video game.

Users access the remote services with client devices (e.g., PC, mobile phone, etc.), which include at least a CPU, a display and I/O, and are capable of communicating with the game server. It should be appreciated that a given video game may be developed for a specific platform and an associated controller device. However, when such a game is made available via a game cloud system, the user may be accessing the video game with a different controller device, such as when a user accesses a game designed for a gaming console from a personal computer utilizing a keyboard and mouse. In such a scenario, an input parameter configuration defines a mapping from inputs which can be generated by the user's available controller device to inputs which are acceptable for the execution of the video game.

In another example, a user may access the cloud gaming system via a tablet computing device, a touchscreen smartphone, or other touchscreen driven device, where the client device and the controller device are integrated together, with inputs being provided by way of detected touchscreen inputs/gestures. For such a device, the input parameter configuration may define particular touchscreen inputs corresponding to game inputs for the video game (e.g., buttons, directional pad, gestures or swipes, touch motions, etc.).

In some embodiments, the client device serves as a connection point for a controller device. That is, the controller device communicates via a wireless or wired connection with the client device to transmit inputs from the controller device to the client device. The client device may in turn process these inputs and then transmit input data to the cloud game server via a network. For example, these inputs might include captured video or audio from the game environment that may be processed by the client device before sending to the cloud game server. Additionally, inputs from motion detection hardware of the controller might be processed by the client device in conjunction with captured video to detect the position and motion of the controller before sending to the cloud gaming server.

In other embodiments, the controller can itself be a networked device, with the ability to communicate inputs directly via the network to the cloud game server, without being required to communicate such inputs through the client device first, such that input latency can be reduced. For example, inputs whose detection does not depend on any additional hardware or processing apart from the controller itself can be sent directly from the controller to the cloud game server. Such inputs may include button inputs, joystick inputs, embedded motion detection inputs (e.g., accelerometer, magnetometer, gyroscope), etc.

Access to the cloud gaming network by the client device may be achieved through a network implementing one or more communication technologies. In some embodiments, the network may include 5th Generation (5G) wireless network technology including cellular networks serving small geographical cells. Analog signals representing sounds and images are digitized in the client device and transmitted as a stream of bits. 5G wireless devices in a cell communicate by radio waves with a local antenna array and low power automated transceiver. The local antennas are connected with a telephone network and the Internet by high bandwidth optical fiber or wireless backhaul connection. A mobile device crossing between cells is automatically transferred to the new cell. 5G networks are just one communication network, and embodiments of the disclosure may utilize earlier generation communication networks, as well as later generation wired or wireless technologies that come after 5G.

In one embodiment, the various technical examples can be implemented using a virtual environment via a head-mounted display (HMD), which may also be referred to as a virtual reality (VR) headset. As used herein, the term generally refers to user interaction with a virtual space/environment that involves viewing the virtual space through an HMD in a manner that is responsive in real-time to the movements of the HMD (as controlled by the user) to provide the sensation to the user of being in the virtual space or metaverse. An HMD can be worn in a manner similar to glasses, goggles, or a helmet, and is configured to display a video game or other metaverse content to the user. The HMD can provide a very immersive experience in a virtual environment with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures (e.g., commands, communications, pointing and walking toward a particular content item in the scene, etc.). In one embodiment, the gestures can be tracked and processed by the system to generate a prediction of interaction with the particular content item in the game scene. In some embodiments, machine learning may be used to facilitate or assist in the prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network, such as internet, cellular, etc. In one embodiment, the cloud computing and gaming system maintains and executes the video game being played by the user. In some embodiments, the cloud computing and gaming system is configured to receive inputs from the HMD and/or interfacing objects over the network. The cloud computing and gaming system is configured to process the inputs to affect the game state of the executing video game. The output from the executing video game, such as video data, audio data, and haptic feedback data, is transmitted to the HMD and the interface objects.

Additionally, though implementations in the present disclosure may be described with reference to n HMD, it will be appreciated that in other implementations, non-HMDs may be substituted, such as, portable device screens (e.g., tablet, smartphone, laptop, etc.) or any other type of display that can be configured to render video and/or provide for display of an interactive scene or virtual environment. It should be understood that the various embodiments defined herein may be combined or assembled into specific implementations using the various features disclosed herein. Thus, the examples provided are just some possible examples, without limitation to the various implementations that are possible by combining the various elements to define many more implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

With the above embodiments in mind, it should be understood that embodiments of the present disclosure can employ various computer-implemented operations involving data stored in computer systems. These operations are those requiring physical manipulation of physical quantities. Any of the operations described herein in embodiments of the present disclosure are useful machine operations. Embodiments of the disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server, or by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator that emulates a processing system.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method, comprising:
receiving a request for a highlight reel of a video game, wherein the request includes a story class for the highlight reel, wherein the video game includes a plurality of playable events that are predefined, wherein the plurality of playable events are configured in an arc order consistent with a story arc of the video game;
selecting one or more playable events from the plurality of playable events to architect a mini story arc for the highlight reel based on the story class;
accessing a plurality of clips corresponding with the one or more playable events that are selected for the mini story arc; and
generating the highlight reel based on the plurality of clips that follows the mini story arc that is architected with the one or more playable events.

2. The method of claim 1,
wherein the plurality of playable events is identified and tagged during development of the video game.

3. The method of claim 1, further comprising:
collecting a plurality of game plays of the video game being played by a plurality of players;
extracting a plurality of features from the plurality of game plays, wherein the plurality of features is related to one or more events occurring in the plurality of game plays; and
inputting the plurality of features into a deep learning engine that is configured to identify and output the plurality of playable events.

4. The method of claim 1, further comprising:
providing as input the plurality of playable events, the arc order, and the story class for the highlight reel into a deep learning engine implementing generative artificial intelligence; and
using generative artificial intelligence as implemented by the deep learning engine for architecting the mini story arc with the one or more playable events.

5. The method of claim 4, further comprising:
providing as input to the deep learning engine the one or more playable events and a plurality of user generated content of one or more game plays of one or more users playing the video game; and
using the generative artificial intelligence as implemented by the deep learning engine for selecting the plurality of clips corresponding with the one or more playable events that are selected to architect the mini story arc.

6. The method of claim 5,
wherein the plurality of user generated content is recorded and stored by a proprietary gaming service, that provides gaming access to the video game, or by a third party source.

7. The method of claim 1,
wherein the story class defines a complexity and duration of the highlight reel.

8. The method of claim 1,
wherein the story class defines a limited period of the story arc for the mini story arc.

9. The method of claim 1,
wherein the plurality of playable events that are predefined include at least one of the following:
a key event that is required within the story arc; and
a critical event that is descriptive of the mini story arc; and
an ordinary event that links a first event and a second event of the plurality of playable events that are predefined.

10. A computer system comprising:
a processor;
memory coupled to the processor and having stored therein instructions that, if executed by the computer system, cause the computer system to execute a method for implementing a graphics pipeline, comprising:
receiving a request for a highlight reel of a video game, wherein the request includes a story class for the highlight reel, wherein the video game includes a plurality of playable events that are predefined, wherein the plurality of playable events are configured in an arc order consistent with a story arc of the video game;
selecting one or more playable events from the plurality of playable events to architect a mini story arc for the highlight reel based on the story class;
accessing a plurality of clips corresponding with the one or more playable events that are selected for the mini story arc; and
generating the highlight reel based on the plurality of clips that follows the mini story arc that is architected with the one or more playable events.

11. The computer system of claim 10,
wherein in the method the plurality of playable events is identified and tagged during development of the video game.

12. The computer system of claim 10, the method further comprising:
providing as input the plurality of playable events, the arc order, and the story class for the highlight reel into a deep learning engine implementing generative artificial intelligence; and
using generative artificial intelligence as implemented by the deep learning engine for architecting the mini story arc with the one or more playable events.

13. The computer system of claim 12, the method further comprising:
providing as input to the deep learning engine the one or more playable events and a plurality of user generated content of one or more game plays of one or more users playing the video game; and
using the generative artificial intelligence as implemented by the deep learning engine for selecting the plurality of clips corresponding with the one or more playable events that are selected to architect the mini story arc.

14. The computer system of claim 10,
wherein in the method the story class defines a complexity and duration of the highlight reel.

15. The computer system of claim 10, wherein in the method the plurality of playable events that are predefined include at least one of the following:
a key event that is required within the story arc; and
a critical event that is descriptive of the mini story arc; and
an ordinary event that links a first event and a second event of the plurality of playable events that are predefined.

16. A non-transitory computer-readable storage medium storing a computer program executable by a processor-based system, comprising:
program instructions for receiving a request for a highlight reel of a video game, wherein the request includes a story class for the highlight reel, wherein the video game includes a plurality of playable events that are predefined, wherein the plurality of playable events are configured in an arc order consistent with a story arc of the video game;
program instructions for selecting one or more playable events from the plurality of playable events to architect a mini story arc for the highlight reel based on the story class;
program instructions for accessing a plurality of clips corresponding with the one or more playable events that are selected for the mini story arc; and
program instructions for generating the highlight reel based on the plurality of clips that follows the mini story arc that is architected with the one or more playable events.

17. The non-transitory computer-readable storage medium of claim 16,
wherein in the program instructions the plurality of playable events is identified and tagged during development of the video game.

18. The non-transitory computer-readable storage medium of claim 16, further comprising:
program instructions for providing as input the plurality of playable events, the arc order, and the story class for the highlight reel into a deep learning engine implementing generative artificial intelligence; and
program instructions for using generative artificial intelligence as implemented by the deep learning engine for architecting the mini story arc with the one or more playable events.

19. The non-transitory computer-readable storage medium of claim 18, further comprising:
program instructions for providing as input to the deep learning engine the one or more playable events and a plurality of user generated content of one or more game plays of one or more users playing the video game; and
program instructions for using the generative artificial intelligence as implemented by the deep learning engine for selecting the plurality of clips corresponding with the one or more playable events that are selected to architect the mini story arc.

20. The non-transitory computer-readable storage medium of claim 16,
wherein in the program instructions the story class defines a complexity and duration of the highlight reel.
